(19) United States
(12) Patent Application Publication
(10) Pub. No.: US 2013/0281895 A1
(43) Pub. Date: Oct. 24, 2013

(54) Special step through ambulation aid device

(71) Applicant: Susan Keeker, Anderson, IN (US)

(72) Inventor: Susan Keeker, Anderson, IN (US)

(21) Appl. No.: 13/866,932

(22) Filed: Apr. 19, 2013

Related U.S. Application Data
(60) Provisional application No. 61/637,295, filed on Apr. 24, 2012.

(51) Int. Cl. A61H 3/00

(52) U.S. Cl. CPC A61H 3/00
USPC 601/27

(57) ABSTRACT

A device called a step-through ambulation aid which targets deficits encountered due to lower extremity paresis involving poor hip flexion. The device is comprised of a slidable plate that surrounds an inner liner. The plate surrounds a patient's foot and has a means to removably secure the device to the patient's foot. The use of the Step-Through Ambulation aid device on the bottom of a shoe allows reduction in friction forces encountered across most surfaces, including carpet, tile, wood, asphalt, and cement. The thin, smooth surface of the aid allows the foot to glide forward with virtually no resistance or friction from the walking surface. As a result, ambulation without additional physical assistance for leg advancement is made possible.

### CROSS-REFERENCE TO RELATED APPLICATIONS

This application claims the benefit of Provisional Patent Application Ser. No. 61/637,295 filed Apr. 24, 2012 by Susan Keeker entitled “Special step through ambulation aid device”.

### FIELD OF INVENTION

The present disclosure of a Special step through ambulation aid device is generally related to devices, systems and methods for controlling, and assisting in, the movement of an impaired human's limb and more specifically to methods and configurations of devices for assisting a human in the movement of their leg during rehabilitation.

The present invention relates also to ambulatory assistance devices, and more particularly to an ambulatory assistance device that is capable of helping an individual, having partial or total lower body paralysis, in a standing position and walking under the individual's own power. [Such a device is known as an orthotic or orthosis, which is an artificial or mechanical aid used to support or to assist movement of a weak or injured part of the body]. The present invention relates to leg orthoses, more specifically to passive orthoses for gait training. Finally, the present invention relates to the general art of therapeutic devices, and to the particular field of therapeutic devices for guiding or permit a patient's foot position to easily move during a period of recuperation or rehabilitation. The applications anticipate original equipment device used in hospitals, nursing homes and home therapeutic activities.

### FEDERALLY SPONSORED RESEARCH

None.

### SEQUENCE LISTING OR PROGRAM

None.

### BACKGROUND

### Field of Invention and Prior Art

### A. Background

The Step-Through Ambulation Aid device is targeted to help as follows: Lower extremity weakness (paresis) can result from a variety of disabling conditions, including stroke, brain injury, cerebral palsy and other neurologic events. Paresis is characterized by the reduction or complete inability to generate force in the muscles of the effected extremity during gait. In stroke and brain injury survivors, this paresis occurs in the muscle group contra lateral to the location of the infarct. If the stroke occurs in the right side of the brain, the muscles in the left side of the body will be affected. This phenomenon results from the disruption of the neural pathways connecting the brain to the muscles of the extremities, leading to reduced motor recruitment and muscle atrophy. One significant result of inadequate muscle force generation is the inability to advance the lower extremity forward or clear the toes when walking causing gait impairment.

There are essentially eight (8) phases of the typical gait cycle, including the loading response, mid stance, terminal stance, pre-swing, initial swing, mid swing, terminal swing and push off. Paresis in the muscles that lift the foot (ankle dorsiflexors) often results in foot drop, or poor foot clearance during the swing phase. This is can be corrected by use of a brace called an ankle-foot orthosis (AFO). For many survivors, this along with therapeutic intervention is enough to enable functional gait. However, if, in addition to weak dorsiflexors, the muscles that move the thigh forward (hip flexors) are significantly impaired, the person will be unable to lift the limb and progress it forward during the swing phase of the gait cycle, placing the person at a high risk for falls. In many cases, the need for assistance of another person to physically lift the leg during the swing phase, results in persons opting for wheelchair use.

### B. Problem Solved

The Step-Through Ambulation Aid targets deficits encountered due to lower extremity paresis involving poor hip flexion. The application of the Step-Through Ambulation aid to the bottom of a shoe, allows reduction in friction forces encountered across most surfaces, including carpet, tile, wood, asphalt, metal, and cement. The thin, smooth surface of the aid allows the foot to glide forward with virtually no resistance or friction from the walking surface. As a result, ambulation without additional physical assistance for leg advancement is made possible.

### C. Prior Art

As far as known, there are no Special step through ambulation aid device or the like. It is believed that this product is unique in its design and technologies. In the FIGS. 6 A through 6 G are sketches of Prior Art considered. Here are shown U.S. Pat. No. 4,702,020—curling slider by Koeger 91 from various views and US Publication—2006/0167392-adjustable leg sling by Manquez 95. The U.S. Pat. No. '020, the curling slider by Koeger, shows a curling slider that is formed from a rigid flat plate member of stainless steel which is hard chromed on an underside. The plate has up curved side and front edges to avoid scoring of the ice. It is attached to a rigid plastic inner by rear side tabs which receive a flange of the inner and a front tab which is attached to a toe cap portion of the inner. A strap between side walls of the inner is hinged at both ends to the inner so that the rigid inner remains stationary while the shoe flexes. A gripper can be applied to the undersurface of the inner with the plate readily removable. The plate can be attached directly to the sole of a shoe by adhesive and a pin. The use is for athletic type activities. The device taught has no optional pull straps or use suggested for physical therapy or rehabilitation efforts. The US Publication '7392 shows an adjustable leg sling by Manquez 95. Here is demonstrated a low cost, compact and lightweight sling. It can be appreciated that moving an impaired leg often requires someone to bend down and place their hands near the ground to grasp the leg. For many, this requirement to bend over is burdensome and can leave on in an awkward situation. In accordance with the Manquez invention, an impaired leg can be moved without the requirement of bending over to grasp the leg and then lifting the leg. The sling is not used in rehabilitation and a slider cast in combination with the sling is not taught. Therefore the device can not accomplish the use shown by the Keeker device.

FIG. 7 A through 7 C are additional sketches of other prior art considered and reviewed. In these sketches are shown U.S. Pat. No. 1,744,003 by Gallager called a supplementary outsole 96. This invention relates to footwear, such as boots and shoes, and relates more particularly to the treads or supplementary outsoles for boots and shoes. The principal object of the invention is to provide treads or supplementary outsoles. These treads may be easily applied by an unskilled person to worn boots or shoes in order to repair the shoes or boots. Again, this device can not accomplish the physical therapy and rehabilitation use shown by the Keeker special step through ambulation aid device. In the FIG. 7 are also shown two older patents. U.S. Pat. No. 1,866,006 is a coasting attachment 97 issued to Bergstrand. It demonstrates an attachment to apply to a shoe for use principally in coasting. It provides a detachable toe cap, preferably of metal, with means on the side for use in steering and with a member on the front or end of the toe for use particularly in starting the sled with the foot; it also provides a simple and convenient construction which can be sold at a low price and it provides, in association with the part used in starting the sled, a spur for assistance in walking on the ice. Finally, U.S. Pat. No. 745,442 is a coasting attachment 98 taught by Innes. It teaches and relates to a new and novel coasting shoe attachment. The aim was to provide a simple attachment adapted to be removably secured to a shoe and used by a boy or person who is coasting. Neither Bergstrand nor Innes anticipates nor is a means to accomplish the physical therapy and rehabilitation use as shown with the Keeker device.

### SUMMARY OF THE INVENTION

This invention is a Special step through ambulation aid device. Taught here are the ways a Special step through ambulation aid device 31 may be placed safely and securely on a patient's foot (in a shoe) for rehabilitation therapy. This may be used in hospitals, rehabilitation centers, at home or at a nursing home where rehabilitation therapy occurs.

The preferred embodiment of a special step through ambulation aid device 31 comprising a slide surface plate 59 formed from a durable, glidable material which is of a thickness to remain rigid against flexing forces applied by the foot of the patient's 100 foot and to have an up-curved edge around the periphery (front 59A, sides 59C and rear 59B) thereof so as to allow sliding on a walking surface 115 without significant resistance, said slide surface plate 59 being with sufficient glidable characteristics on at least the surface of the plate contiguous to the walking surface 115 thereof and a rigid inner liner 60 of a durable material having a substantially planar wall for underlying in a contiguous manner at least a front sole portion of a shoe 80 of the patient 100, an upstanding side wall 62 means around at least the toe and side portions of the periphery of the side wall and means 40 for securely attaching said sidewall 62, such as an adjustable back strap to a shoe 80 of the patient 100, an open area 62A between sidewall 62 and toe prong 50, said device 31 including means 48, such as an adhesive or fasteners, for attachment thereof to said liner 60 at an underside (opposite the walking surface side) of the plate 59, wherein said plate 59 is separable from said liner 60. An alternative embodiment is comprised of the preferred device with an adjustable sling 70 as an optional component to help with the initial steps and to help create confidence in the initial ambulation therapy.

The newly invented Special step through ambulation aid device 31 may be manufactured at low volumes by very simple means and in high volume production by more complex and controlled systems. Processes and manufacturing equipment to produce is readily available.

### OBJECTS AND ADVANTAGES

The Special step through ambulation aid device 31 has several specific objectives:
1) A principal object of the present invention is to provide an ambulatory assistance device that assists an individual to ambulate from one location to another, under the individual's manual power, without supporting a majority of the individual's body on a wheeled structure.
2) A further object of the present invention is to provide an ambulatory assistance device that assists ambulation of the individual in a generally upright position.
3) Yet another object of the present invention is to provide an ambulatory assistance device that provides the user with an easy means of ambulation and total-body, therapeutic exercise.
4) A further object of the present invention is to provide an ambulatory assistance device that is relatively simple and inexpensive in construction.
5) Still another object of the present invention is to provide an ambulatory assistance device that may be used by individuals of nearly any size and physical ability.
6) Still another object of the present invention is to provide an ambulatory assistance device that ambulates an individual in a generally vertical position with less energy expenditure than prior devices and methods.
7) It is yet another object of this invention to provide an assistance device which develops improved stability to the patient.
8) One aspect of the invention comprises gait training apparatus for providing leg swing assistance to a patient.
9) It is an object of the present invention to provide a therapeutic device for assisting in the movement and orientation of a patient's foot with respect to the patient's leg during a recovery period.
10) It is another object of the present invention to provide a therapeutic device for assisting in the movement and orientation of a patient's foot with respect to the patient's leg during a recovery period and a device which can be worn while the patient walks.

With the foregoing in view, and other advantages as will become apparent to those skilled in the art to which this invention relates as this specification proceeds, the invention is herein described by reference to the accompanying drawings forming a part hereof, which includes a description of the best mode known to the applicant and of the preferred typical embodiment of the principles of the present invention.

### DESCRIPTION OF THE DRAWINGS

The accompanying drawings, which are incorporated in and constitute a part of this specification, illustrate an embodiment of the Special step through ambulation aid device that is preferred. The drawings together with the summary description given above and a detailed description given below serve to explain the principles of the Special step through ambulation aid device. It is understood, however, that the Special step through ambulation aid device is not limited to only the precise arrangements and instrumentalities shown.

FIGS. 1 A through 1 D are sketches of the general Special step through ambulation aid device.

FIGS. 2 A and 2 B are sketches of the general Special step through ambulation aid device with components and features noted.

FIGS. 3 A through 3 E are sketches of a prototype sample (with the components and features) being placed on a shoe, the sketches being shown from generally a side view.

FIGS. 4 A through 4 F are sketches of a prototype sample in operation on a patient being aided by the Special step through ambulation aid device.

FIGS. 5 A through 5 E are sketches of a prototype sample with the components and features of the Special step through ambulation aid device.

FIGS. 6 A through 6 G are sketches of Prior Art considered.

FIG. 7 A through 7 C are additional sketches of Prior Art considered.

### DESCRIPTION OF THE DRAWINGS

### Reference Numerals

The following list refers to the drawings:

TABLE B
Reference numbers

| Ref # | Description |
|---|---|
| 31 | Special Step Thru Ambulation Aid |
| 31A | Side View Of Device |
| 31B | General Isometric View Of Device |
| 31C | General Top View Of Device |
| 31D | Section CC Through Device |
| 40 | Means for securely attaching upstanding sidewall 62 to a shoe |
| | 80 - such as but not limited to a Back Strap |
| 41 | Swivel Strap end “YOKE” (Bifurcated Structure) |
| 42 | Pivoted Pin Connecting Strap End |
| 42A | Aperture For Pivot Pin |
| 43 | Connector Loop |
| 44 | Means to Adjust Back Strap |
| 48 | Adhesive/Means to Connect Liner 60 and Sidewall 62 to Slide |
| | Surface 59 |
| 50 | Toe Prong |
| 55 | Option Tab Slide Surface Over Lines 60 |
| 59 | Slide Surface |
| 59A | Verticle transition To Front Surface |
| 59B | Rear Up Turn |
| 59C | Curved Slides |
| 60 | Lines Of Inside Device |
| 62 | Side Wall Of Device |
| 62A | Open area 62A between sidewall 62 and toe prong 50 |
| 63 | Means To Connect Slide Surface 59 to Toe Prong |
| 64 | Front Connector To Slide Surface |
| 65 | Front Portion of Slide Surface |
| 70 | Adjustable Sling as an option to help create confidence in the |
| | initial ambulation therapy |
| 71 | Handle |
| 72 | Adjustable Strap |
| 73 | Strap Means To Adjust And Hold In Place |
| 74 | Means To Hold Clip 75 To Strap 73 |
| 75 | Spring Clip |
| 75A | an extended end of the spring clip 75 |
| 78 | Means To Connect Receiving Pin To Back Strap 40 |
| 79 | Receiving Ring For Adjustable Sling |
| 80 | Shoe |
| 91 | U.S. Pat. No. 4,702,020 - Curling Slider By Koeger |
| 95 | US Publication - 2006/0167392 - Adjustable Leg Sling By |
| | Manquez |
| 96 | U.S. Pat. No. 1,744,003 - Supplementary Outsole by Gallager |
| 97 | U.S. Pat. No. 1,866,006 Coasting Attachment By Bergstrand |
| 98 | U.S. Pat. No. 745,442 Coasting Attachment By Innes |
| 100 | Patient |
| 103 | Hand Rail |
| 105 | Physical therapist or aid to Patient 100 |
| 110 | Walk Aid |
| 115 | Walking surface |

### DETAILED DESCRIPTION OF PREFERRED EMBODIMENT

The present development is a Special step through ambulation aid device. Particularly this ambulation assistance device is generally related to devices, systems and methods for controlling, and assisting in, the movement of an impaired human's limb and more specifically to methods and arrangements for assisting a human in the movement of their leg during rehabilitation. More particularly, the device is related to an ambulatory assistance device that is capable of helping an individual, having partial or total lower body paralysis, in a standing position and walking under the individual's own power.

The specific objects and advantages of this device are delineated in detail in the paragraphs, above. The preferred embodiment of a Special step through ambulation aid device 31 A special step through ambulation aid device 31 comprising: (a) a slide surface plate 59 formed from a durable, glidable material which is of a thickness to remain rigid against flexing forces applied by a foot of a patient 100 and the plate 59 to have an up-curved edge around the periphery (front 59A, sides 59C and rear 59B) thereof so as to allow sliding of the plate 59 on a walking surface 115 without significant resistance, the slide surface plate 59 being with sufficient glidable characteristics on at least a bottom surface of the plate which is contiguous to the walking surface 115 thereof; (b) a rigid inner liner 60 of a durable material having a substantially planar wall for underlying in a contiguous manner at least a front sole portion of a shoe 80 of the patient 100; (c) an upstanding side wall 62 means around at least a toe and a side portion of the periphery of the upstanding sidewall 62; (d) a means 40 for securely attaching said upstanding sidewall 62, such as an adjustable back strap to a shoe 80 of the patient 100; (e) an open area 62A between the upstanding sidewall 62 and a toe prong 50; and (f) said device 31 including a means 48, such as an adhesive or fasteners, for securely attaching the liner 60 at an underside, the underside being a surface opposite a bottom walking surface side of the plate 59 wherein the special step through ambulation aid device 31 surrounds the shoe on the foot of the patient and allows reduction in friction forces encountered across most walking surfaces, including carpet, tile, wood, asphalt, metal and cement which in turn allows the foot of the patient to glide forward with virtually no resistance and friction from the walking surface which results in ambulation during therapy without additional physical assistance. An alternative embodiment is comprised of the preferred device with an optional, adjustable sling 70 to help with the initial ambulation therapy.

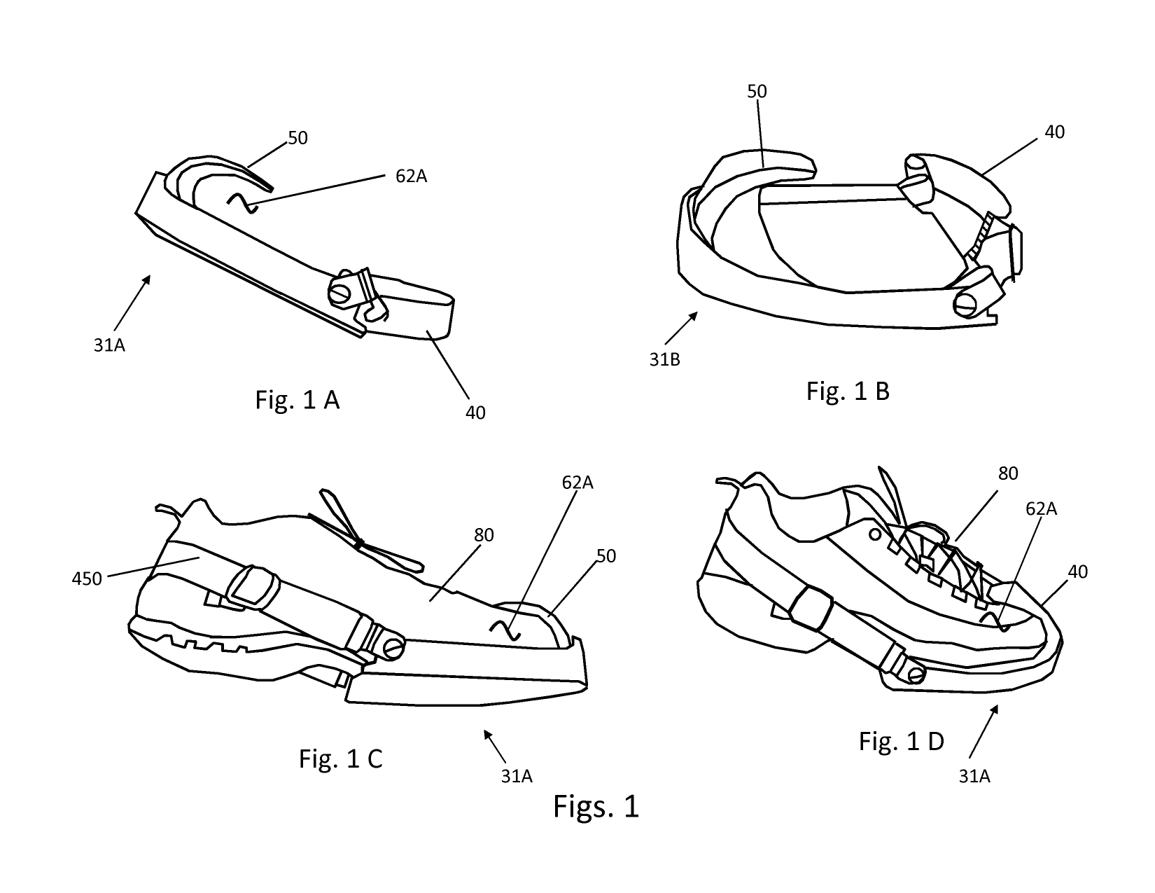

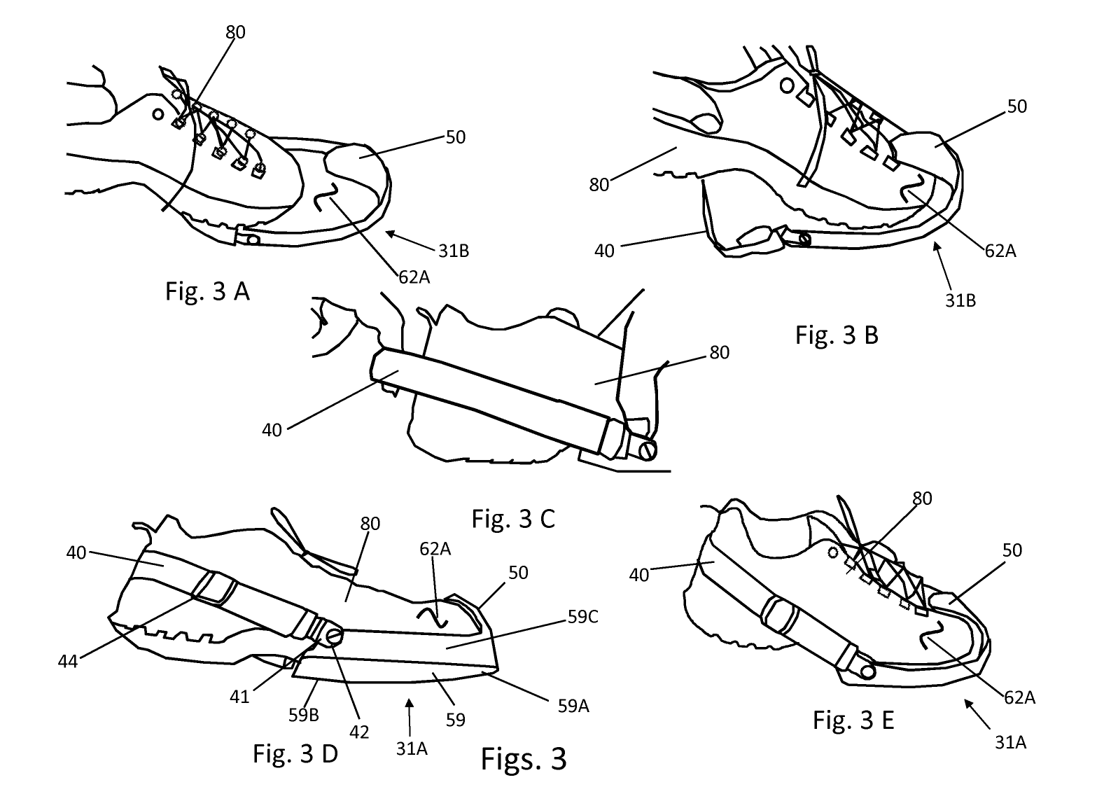

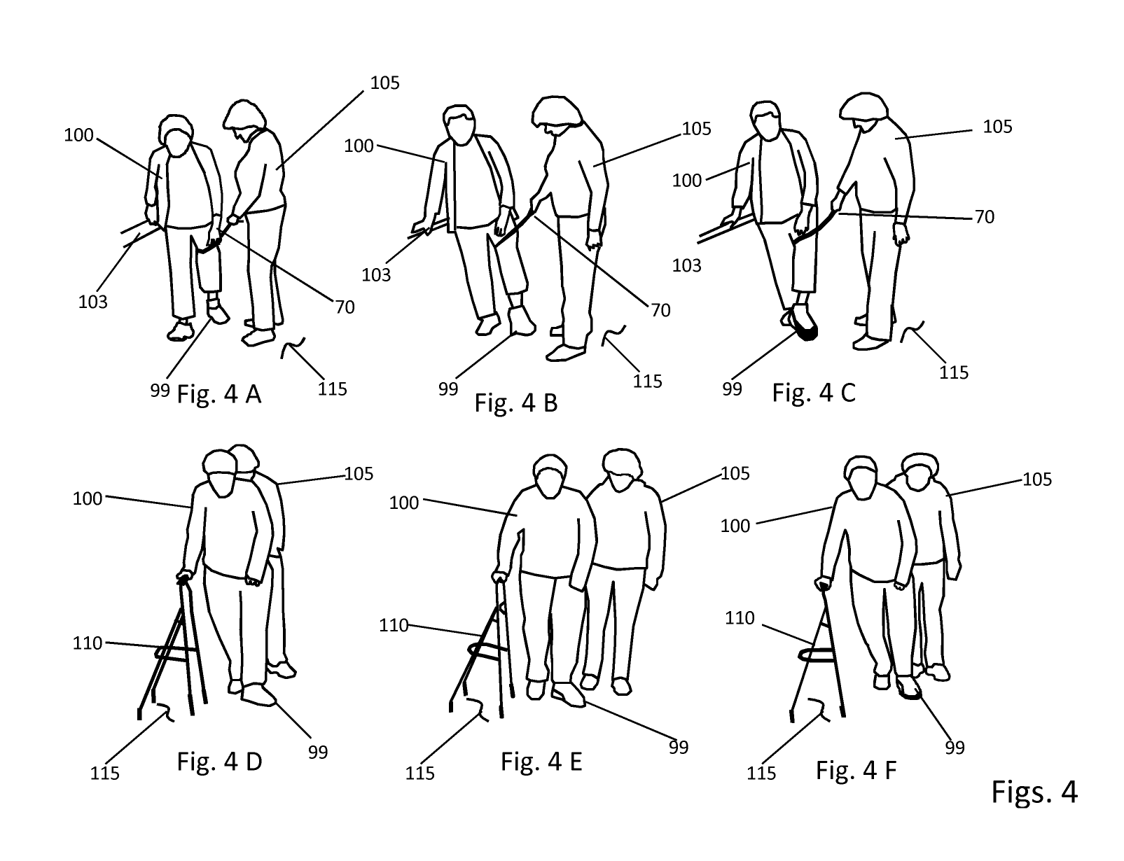

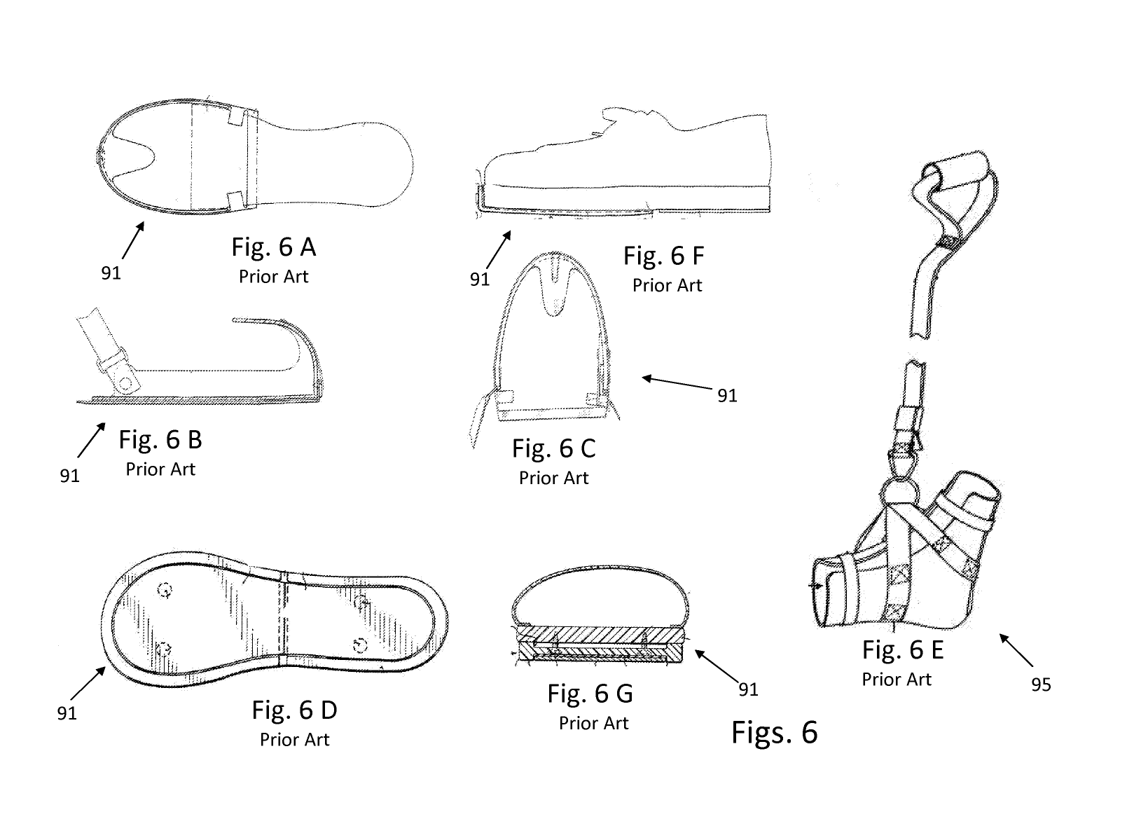

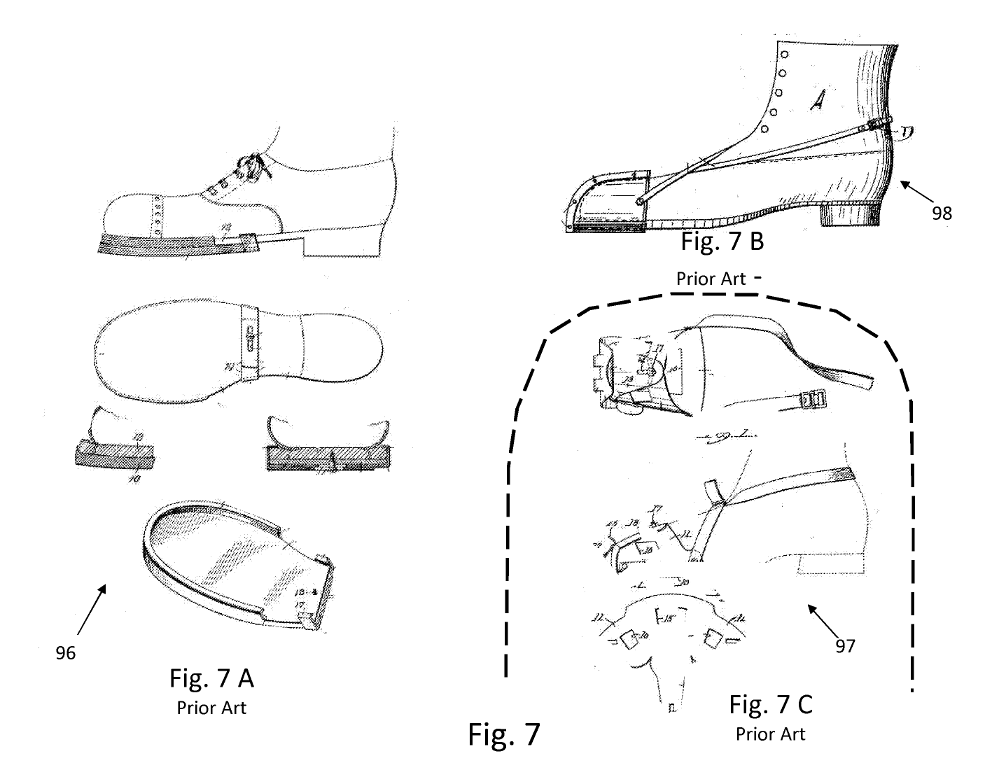

There is shown in FIGS. 1-7 a complete description and operative embodiment of the Special step through ambulation aid device 31. In the drawings and illustrations, one notes well that the FIGS. 1-7 demonstrate the general configuration and use of this product. FIGS. 1, 2, 3, and 5 show details of the device. FIGS. 3 and 4 show the operation. FIGS. 6 and 7 are reference sketches of prior art. The various example uses are in the operation and use section, below.

The accompanying drawings, which are incorporated in and constitute a part of this specification, illustrate an embodiment of the Special step through ambulation aid device 31 that is preferred. The drawings together with the summary description given above and a detailed description given below serve to explain the principles of the Special step through ambulation aid device 31. It is understood, however, that the Special step through ambulation aid device 31 is not limited to only the precise arrangements and instrumentalities shown. Other examples of ambulatory aiding devices and uses are still understood by one skilled in the art of ambulatory and therapy devices and system to be well within the scope and spirit shown here.

FIGS. 1 A through 1 D are sketches of the general Special step through ambulation aid device 31. Shown here is the general device 31 from a side view 31A and anisometric view 31B. One notes the means 40 (such as an adjustable strap or the like) to removably connect the device 31 to the shoe 80. Also one may view the toe prong 50 that retains the shoe 80 with the device 31.

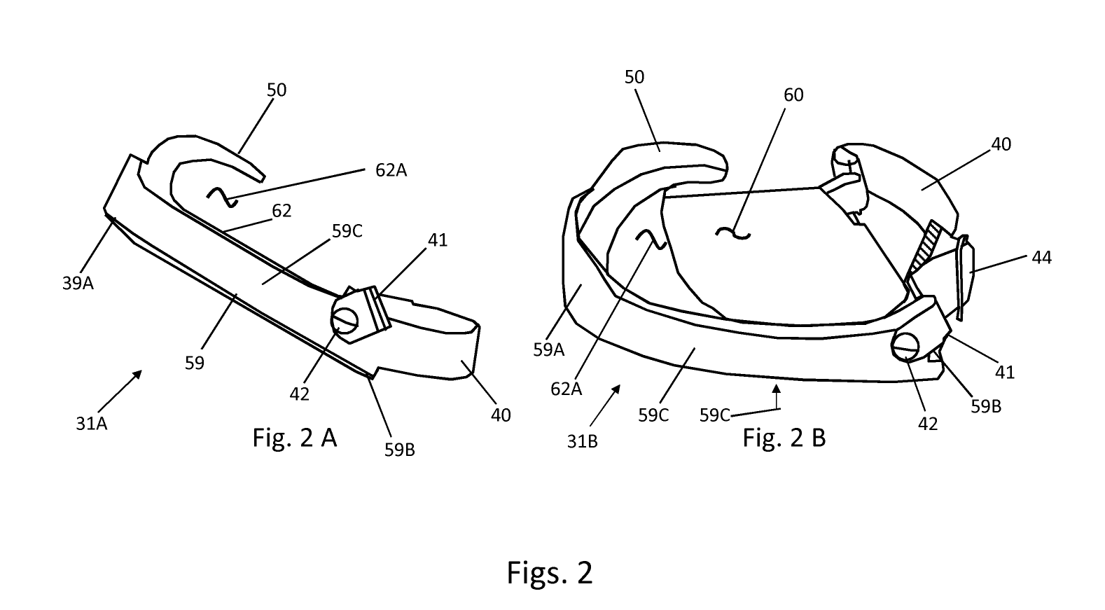

FIGS. 2 A and 2 B are sketches of the general Special step through ambulation aid device 31 with components and features noted. In the side view 31A and isometric view 31B are shown: the means 40 to removably connect the device 31 to the shoe 80; a swivel strap end “YOKE” (bifurcated structure) 41; pivoted pin connecting strap end 42; aperture for pivot pin 42A; means to adjust back strap 44; toe prong 50; slide surface 59; vertical transition to front surface 59A of plate 59; rear up turn 59B to plate 59; curved sides 59C to plate 59; an open area 62A between sidewall 62 and toe prong 50; and a liner 60 of inside device 31 side wall of device 62. Material for toe prong 50 and the means 40 is a flexible and durable for example, and not as a limitation, fabric, leather, plastic, composite material, cotton, denim, wood, canvas, rubber, plastics, and other petrochemical-derived materials, PVC, PU, leatherette and polymeric.

FIGS. 3 A through 3 E are sketches of a prototype sample (with the components and features) being placed on a shoe, the sketches being shown from generally a side view. FIGS. 4 A through 4 F are sketches of a prototype sample in operation on a patient being aided by the Special step through ambulation aid device. These are discussed below in the operation and use section.

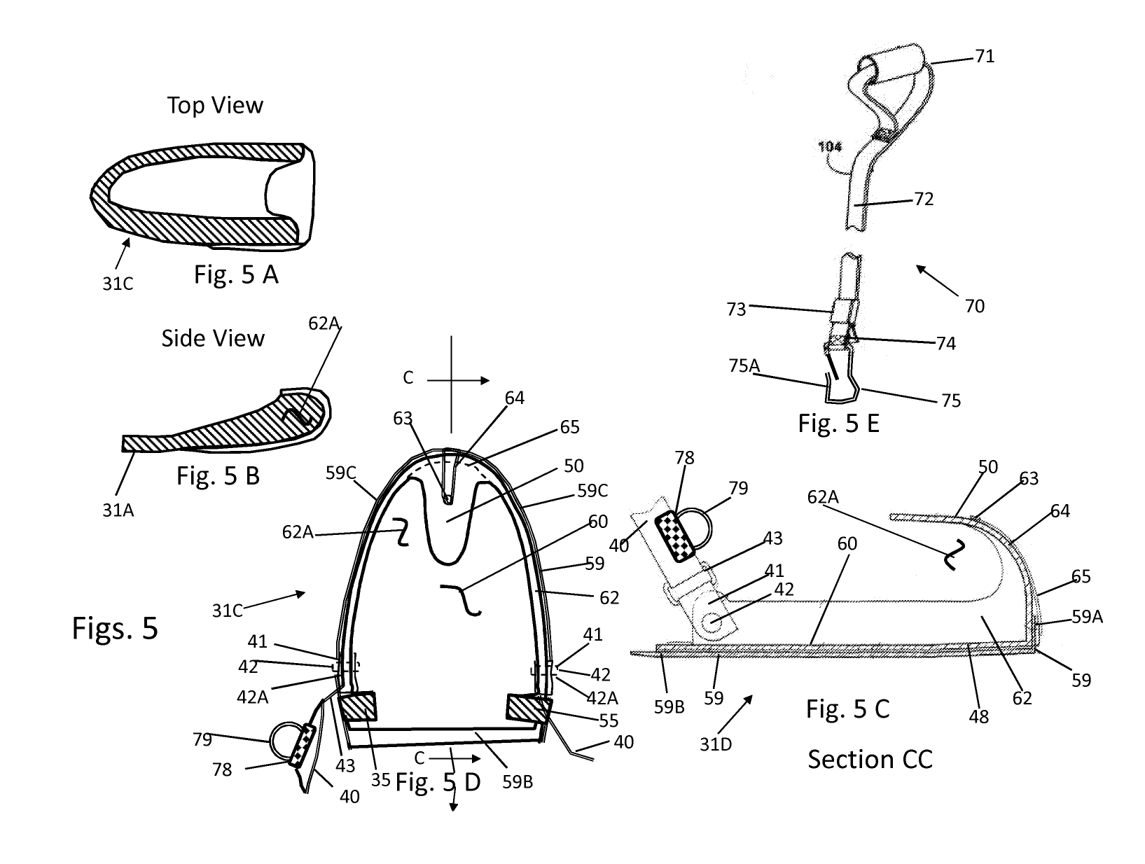

FIGS. 5 A through 5 E are sketches of a prototype sample with the components and features of the Special step through ambulation aid device 31. Note FIG. 5 C is a Section C-C through device 31D. Shown in these views are a means 40 to removably connect the device 31 to the shoe 80; swivel strap end “YOKE” (bifurcated structure) 41; pivoted pin connecting strap end 42; aperture for pivot pin 42A connector loop 43; means to adjust back strap 44 (not shown); adhesive/means 48 to connect liner 60 and sidewall 62 to slide surface 59; toe prong 50; option tab slide surface 55 over liner 60; slide surface 59; vertical transition to front surface 59A of plate 59; rear up turn 59B to plate 59 curved sides 59C to plate 59; an open area 62A between sidewall 62 and toe prong 50; liner 60 of inside device 31 side wall of device 62; means 63 to connect slide vertical surface 59A to toe prong 40; front connector 64 to slide surface 59A; and a front portion of slide surface 65. One notes that the slide plate 59 may be plastic, urethane, Teflon™, neoprene or other composite materials in addition to a metal such as chrome plated steel or aluminum and the like. Also in FIGS. 5 C, D, and E are the optional adjustable sling 70 with a handle 71; an adjustable strap 72; a strap means 73 for adjusting and holding the strap 72 securely yet removably in place and at a desired, predetermined length; a spring clip 75 with an extended end 75A; a means 74 such as a loop of the strap 72 for holding spring clip 75 to strap 72; a means 78 for connecting the receiving pin to back strap 40; and a receiving ring 79 for retaining the extended end 75A of the adjustable sling 70.

FIGS. 6 A through 6 G are sketches of Prior Art considered. Here are shown U.S. Pat. No. 4,702,020—Curling Slider by Koeger 91 from various views and US Publication—2006/0167392—Adjustable Leg Sling by Manquez 95. FIG. 7 A through 7 C are additional sketches of Prior Art considered. In these sketches are shown U.S. Pat. No. 1,744,003—Supplementary Outsole by Gallager 96; U.S. Pat. No. 1,866,006 Coasting Attachment by Bergstrand 97; and U.S. Pat. No. 745,442 Coasting Attachment by Innes 98. These are discussed in the Prior Art section, above.

The details mentioned here are exemplary and not limiting. Other specific components and manners specific to describing a Special step through ambulation aid device 31 may be added as a person having ordinary skill (in the field of devices and systems for ambulatory care and therapy) will well appreciates.

### Operation of the Preferred Embodiment

The Special step through ambulation aid device 31 has been described in the above embodiment. The manner of how the device operates is described below. One notes well that the description above and the operation described here must be taken together to fully illustrate the concept of the Special step through ambulation aid device 31. The preferred embodiment of a Special step through ambulation aid device 31 comprising a slide surface plate 59 formed from a durable, glidable material which is of a thickness to remain rigid against flexing forces applied by the foot of the patient's 100 and to have an up-curved edge around the periphery (front 59A, sides 59C and rear 59B) thereof so as to allow sliding on a walking surface 115 without significant resistance, said slide surface plate 59 being with sufficient glidable characteristics on at least the surface of the plate contiguous to the walking surface 115 thereof and a rigid inner liner 60 of a durable material having a substantially planar wall for underlying in a contiguous manner at least a front sole portion of a shoe 80 of the patient 100, an upstanding side wall 62 means around at least the toe and side portions of the periphery of the side wall and means 40 for attaching said sidewall 62, such as an adjustable back strap to a shoe 80 of the patient 100, said device 31 including means 48, such as an adhesive or fasteners, for attachment thereof to said liner 60 at an underside (opposite the walking surface side) of the plate 59, wherein said plate 59 is separable from said liner 60. An alternative embodiment that is optional is comprised of the preferred device with the optional, adjustable sling 70 to help with the initial ambulation therapy in order to help build the confidence of the patient with the device.

Many places and uses are anticipated for the Special step through ambulation aid device 31. Some examples, and not limitations, are shown in the following Table.

| ITEM | DESCRIPTION |
|---|---|
| 1 | In a hospital environment |
| 2 | In a therapy or rehabilitation |
| | center |
| 3 | At a nursing or assisted living |
| | care center |
| 4 | At a patient's home |

FIGS. 3 A through 3 E are sketches of a prototype sample (with the components and features) being placed on a shoe 80, the sketches being shown from generally a side view. Here the shoe 80 is placed into the device 31 with the front of the shoe 80 inside between the liner 60 and the toe prong 50. One notes the open area 62A between sidewall 62 and toe prong 50. Once the device 31 is such that the liner 60 and therefor the device 31 is contiguous and touching the bottom of the shoe 80, then the removable connecting means 40 (such as a strap or the like) is adjusted to firmly and securely hold the device 31 to the shoe. At this point, the patient 100 may put the shoe onto his/her foot and tie the laces securely.

FIGS. 4 A through 4 F are sketches of a prototype sample in operation on a patient 100 being aided by the Special step through ambulation aid device 31. FIGS. 4 A, 4 B and 4 C show the early progression. Here the patient 100 walks with a physical therapist or aid 105 to Patient 100 and an optional sling 70 that is used to pull the foot along until the patient gains confidence and the rehabilitation advances. The foot/leg requiring therapy has the device 31 in place. As a patient 100 uses the handrail 103 for balance, the physical therapist or aid 105 to Patient 100 assists to move the leg by operating the optional sling 70. All the time, the device 31 glides along the walking surface 115 with little or no resistance and this condition helps the therapy session and patient to avoid a stumbling instance for the patient 100. As the patient 100 advances in the therapy, the rehabilitation advances also. FIGS. 4 D, 4 E, and 4 F show the later progression. Here the patient 100 may walk with a walk aid device 115 and the aid (person) 110 stays close. One notes the leg and foot has strengthened to where the optional sling 70 may not be needed and is removed altogether from the preferred device. Still, the device 31 glides along the walking surface 115 with little or no resistance and this condition helps the therapy session and patient to avoid a stumbling instance for the patient 100. Empirical data and use with real therapeutic sessions show a good success rate utilizing the Special step through ambulation aid device 31.

With this description it is to be understood that the Special step through ambulation aid device 31 is not to be limited to only the disclosed embodiment of product. The features of the device are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless they are defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other of the embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless they are otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A special step through ambulation aid device (31) comprising:
(a) a slide surface plate (59) formed from a durable, glidable material which is of a thickness to remain rigid against flexing forces applied by a foot of a patient (100) and the plate (59) to have an up-curved edge around the periphery (front (59A), sides (59C) and rear (59B) thereof so as to allow sliding of the plate (59) on a walking surface (115) without significant resistance, the slide surface plate (59) being with sufficient glidable characteristics on at least a bottom surface of the plate which is contiguous to the walking surface (115) thereof;
(b) a rigid inner liner (60) of a durable material having a substantially planar wall for underlying in a contiguous manner at least a front sole portion of a shoe (80) of the patient (100);
(c) an upstanding side wall (62) means around at least a toe and a side portion of the periphery of the upstanding sidewall (62);
(d) a means (40), made of durable material, for securely attaching said upstanding sidewall (62), such as an adjustable back strap to a shoe 80 of the patient (100);
(e) an open area (62A) between the upstanding sidewall (62) and a toe prong (50), made of durable material; and
(f) a means (48) for securely attaching the liner (60) at an underside, the underside being a surface opposite a bottom walking surface side of the plate (59)
wherein the special step through ambulation aid device (31) surrounds the shoe on the foot of the patient and allows reduction in friction forces encountered across most walking surfaces which in turn allows the foot of the patient to glide forward with virtually no resistance and friction from the walking surface which results in ambulation during therapy without additional physical assistance.

2. The special step through ambulation aid device (31) according to claim 1 further comprising an adjustable sling (70).

3. The special step through ambulation aid device (31) with the adjustable sling (70) according to claim 2 wherein the adjustable sling (70) is comprised of:
(a) a handle (71);
(b) an adjustable strap (72);
(c) a strap means (73) for adjusting and holding the strap (72) securely yet removably in place and at a desired, predetermined length;
(d) a spring clip (75) with an extended end (75A);
(e) a means (74) for holding spring clip (75) to strap (72);
(f) a means (78) for connecting the receiving pin to back strap (40); and
(g) a receiving ring (79) for retaining the extended end (75A) of the adjustable sling (70).

4. The device according to claim 3 wherein the means (74) for holding is a loop of the strap (72).

5. The device according to claim 1 wherein the means (48) for securely attaching the liner (60) is an adhesive.

6. The device according to claim 1 wherein the means (48) for securely attaching the liner (60) is a fastener.

7. The device according to claim 1 wherein the means (40) for securely attaching the upstanding sidewall (62) to a shoe (80) on the patient (100) is an adjustable back strap.

8. The device according to claim 1 wherein the walking surfaces is from the group consisting of carpet, tile, wood, asphalt, metal, and cement.

9. The device according to claim 1 wherein the durable, glidable material of the slide surface plate (59) is from the group consisting of plastic, urethane, Teflon™, neoprene, composite materials, metal, chrome plated steel, and aluminum.

10. The device according to claim 1 wherein the durable material for the toe prong (50) and the means (40) is from the group consisting of fabric, leather, plastic, composite material, cotton, denim, wood, canvas, rubber, plastics, petrochemical-derived materials, PVC, PU, leatherette and polymeric.

11. A Special step through ambulation aid device (31) comprising a slide surface plate (59) formed from a durable, glidable material which is of a thickness to remain rigid against flexing forces applied by a foot of a patient's (100) and said plate (59) to have an up-curved edge around the periphery (front (59A), sides (59C) and rear (59B) thereof so as to allow sliding on a walking surface (115) without significant resistance, said slide surface plate (59) being with sufficient glidable characteristics on at least a bottom surface of the plate contiguous to the walking surface (115) thereof; a rigid inner liner (60) of a durable material having a substantially planar wall for underlying in a contiguous manner at least a front sole portion of a shoe (80) of the patient (100); an upstanding side wall (62) means around at least a toe and a side portions of the periphery of the upstanding side wall (62); a means (40) for attaching said sidewall (62) to a shoe (80) of the patient (100); an open area (62A) between the upstanding sidewall (62) and a toe prong (50); and a means (48) for securely attaching the liner (60) at an underside surface, the underside surface being opposite to a walking surface side of the plate (59) wherein the special step through ambulation aid device (31) surrounds a shoe on the foot of the patient (100) and the device (31) allows reduction in friction forces encountered across most surfaces, which in turn allows the foot of the patient to glide forward with virtually no resistance or friction from the walking surface which results in ambulation during therapy without additional physical assistance.
